(19) United States
(12) Patent Application Publication
(10) Pub. No.: US 2020/0383348 A1
(43) Pub. Date: Dec. 10, 2020

(54) PLANT OIL BASED FAT SPREAD

(71) Applicant: Conagra Foods RDM, Inc., Chicago, IL (US)

(72) Inventors: Josh Gudeman, Omaha, NE (US); Julia Burchell, Omaha, NE (US); Mark Kovacevic, Seattle, WA (US); Serena Brodsky, Superior, CO (US)

(21) Appl. No.: 16/891,461

(22) Filed: Jun. 3, 2020

Related U.S. Application Data
(60) Provisional application No. 62/857,335, filed on Jun. 5, 2019.

(51) Int. Cl. A23D 7/005

(52) U.S. Cl. CPC A23D 7/0056

(57) ABSTRACT

A spreadable plant oil based product is described to include a plant based liquid oil blended with a structuring oil to provide a spreadable product at refrigerated temperatures and a spreadable and stable product at room temperatures. In one or more aspects, the spreadable product is processed with mixing, cooling, shearing, and aeration techniques to provide spreadability not found through mixture of the ingredients alone.

### CROSS-REFERENCE TO RELATED APPLICATIONS

The present application claims the benefit under 35 U.S.C. § 119(e) of U.S. Provisional Application Ser. No. 62/857,335, entitled PLANT OIL BASED FAT SPREAD, filed Jun. 5, 2019. U.S. Provisional Application Ser. No. 62/857,335 is hereby incorporated by reference in its entirety.

### BACKGROUND

“Butter”, “margarine”, and “spread” are common types of fat products. In butter, the fat is animal derived, specifically milk fat. For margarines and spreads, the fat is one or more oils derived from plants, generally grains or vegetables. Plant oil based spreads were initially developed as a low cost alternative to butter but other reasons for their popularity include their perceived advantages over animal derived products, such as avoidance of unhealthy fats. Products made with animal fat contain more saturated fat than those made from plant fats and saturated fat is generally considered to be less healthy.

### SUMMARY

This summary is provided solely as an introduction to subject matter that is fully described in the detailed description and drawings. The summary should not be considered to describe essential features nor be used to determine the scope of the claims. Moreover, it is to be understood that both the summary and the detailed description are examples and explanatory only and are not necessarily restrictive of the subject matter claimed.

Aspects of the disclosure pertain to a spreadable plant oil based product and a method to make a spreadable plant oil based product. In one aspect, the composition includes two ingredients, a structuring oil (e.g., a “hardstock”) and a liquid oil. Additional seasonings or flavorings may be included, such as salt. The ingredients are agitated while rapidly cooling to prevent fatty acids from fully aligning in their crystalline matrix. The mixed ingredients can then be mechanically worked without additional cooling to provide a desired crystallization structure by shearing and permitting the heat of crystallization to occur. Following the mechanical working step, the product is aerated to introduce voids or pockets in or between the crystal structure, which can facilitate a soft and less dense texture while preventing a waxy visual appearance. Since the spreadable plant oil based product does not include water or does not include significant amounts of water, the salt is distributed through and suspended within the spreadable plant oil based product, but not dissolved in the spreadable plant oil based product. Since the salt is suspended, the salt maintains distribution throughout the product during extended durations at various temperatures, such as room temperature, refrigerated temperatures, and transitions therebetween. The product is spreadable at refrigerated temperatures and is stable and spreadable for extended durations at room temperature, with any added salt solids suspended within the product.

### BRIEF DESCRIPTION OF THE DRAWINGS

The detailed description is described with reference to the accompanying figures.

FIG. 1 is a chart illustrating spreadability of plant oil based products prepared according a Commercial Process involving commercial mixing, cooling, shearing, and aeration techniques and according to a Benchtop Process involving mixing, cooling, crystallization without agitation, and no aeration.

FIG. 2 is a flow diagram illustrating a method for producing a plant oil based product in accordance with example implementations of the present disclosure.

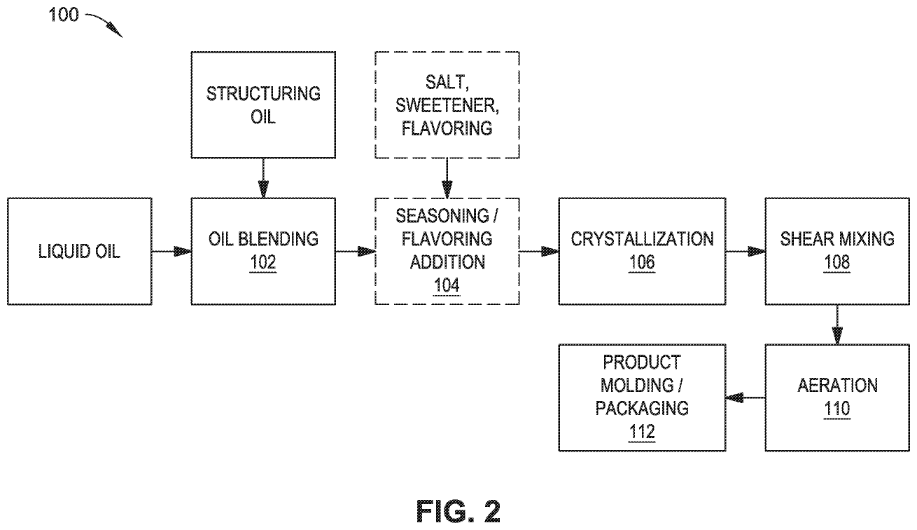

### DETAILED DESCRIPTION

Features of the detailed description may be embodied in many different forms and should not be construed as limited to the combinations set forth herein; rather, these combinations are provided so that this disclosure will be thorough and complete, and will fully convey the scope. Among other things, the features of the disclosure can be embodied as formulations and food products. The following detailed description is, therefore, not to be taken in a limiting sense.

Many fat products such as butters, margarines, and spreads, exhibit different spreadability and stability characteristics depending on the temperature of the fat product. The amount of solid fat present (solid fat content or SFC) in a fat product generally differs based on the temperature, where higher solid fat content typically provides less spreadability than products with lower solid fat content. When refrigerated, most fat products have a solid fat content that inhibits spreadability as compared to room temperature products. If the product is left at room temperature, the solid fat content generally decreases as certain fats begin to melt. For example, butter products do not spread easily at refrigerated temperatures, but permit spreading as the butter approaches room temperatures. Additionally, poor stability of a fat product can result in a melted product with little to no structure, particularly when unrefrigerated, causing the product to be too thin or causing other solids (e.g., salt) to settle to the bottom of the product or product container.

Many fat products include chemical additives, such as emulsifiers, preservatives, chemical stabilizers, artificial ingredients, and the like, to blend ingredients together and maintain stability at room temperatures. Further, many fat products include water, such as to dissolve salt within the product, reduce product costs, and other factors. The presence of water in the product typically necessitates antimicrobial additives to the product to prevent growth of microbes during storage of the product. Moreover, the inclusion of artificial or chemical additives can be a drawback for many consumers.

Aspects of the disclosure pertain to a spreadable plant oil based product and a method to make a spreadable plant oil based product. In one aspect, the composition includes two ingredients, a structuring oil (e.g., a “hardstock”) and a liquid oil to provide a spreadable product at both refrigerated temperatures and room temperatures without added emulsifiers, preservatives, or chemical additives. Additional seasonings or flavorings may be included, such as salt. Since the spreadable plant oil based product does not include water or does not include significant amounts of water, the salt is distributed through and suspended within the spreadable plant oil based product, but not dissolved in the spreadable plant oil based product. The end product may be packaged in molded stick form, similar to a stick of butter, or in a plastic tub or other container. Molded forms of the product may include higher amounts of structuring oil as compared to forms of the product placed in a container. The product is solid but spreadable at refrigeration temperatures and maintains a stable structure at room temperatures. In an aspect, the product is vegan, dairy free, and soy free.

In an aspect, the ingredients of the spreadable plant oil based product are treated with commercial mixing, cooling, shearing, and aeration techniques to provide a spreadability not obtainable through benchtop or countertop mixing. For example, the ingredients can be agitated while rapidly cooling in a scraped surface heat exchanger to prevent fatty acids from fully aligning in their crystalline matrix. The mixed ingredients can then be transferred to a pin worker to mechanically work (e.g., shear) without additional cooling to provide a desired crystallization structure by shearing and permitting the heat of crystallization to occur. Following the mechanical working step, the product is aerated (e.g., via nitrogen introduction) to form voids or pockets in or between the crystal structure, which can facilitate a soft and less dense texture while preventing a waxy visual appearance.

### Ingredients of the Plant Oil Based Product

Liquid Oil

The plant oil based product includes liquid oil to provide variety differentiation in terms of flavor and color, to provide nutrition in the form of unsaturated fatty acids, and to facilitate spreadability of the final product at refrigerated temperatures. As used herein, refrigerated temperatures generally refer to temperatures from about 0° C. (32° F.) to about 4° C. (about 40° F.) that are typically used to delay spoilage of foods during storage, but prevent freezing of any water present in foods. The liquid oil can include, but is not limited to, olive oil, avocado oil, canola oil, sunflower seed oil, flaxseed oil, soybean oil, walnut oil, tomato seed oil, grape seed oil, and combinations thereof. In an aspect, the liquid oil is one of extra virgin olive oil, avocado oil, or a sunflower oil/flaxseed oil mixture. The liquid oil may be extracted from the various plant sources via mechanical pressing without chemical solvents.

In one aspect, the plant oil based product includes the liquid oil in a weight percentage of total content of the product from about 57% to about 75.5%. For example, the weight percentage of the liquid oil in the plant oil based product can be from about 57%, 57.5%, 58%, 58.5%, 59%, 59.5%, 60%, 60.5%, 61%, 61.5%, 62%, 62.5%, 63%, 63.5%, 64%, 64.5%, 65%, 65.5%, 66%, 66.5%, 67%, 67.5%, 68%, 68.5%, 69%, 69.5%, 70%, 70.5%, 71%, 71.5%, 72%, 72.5%, 73%, 73.5%, 74%, 74.5%, 75%, and 75.5% to about 57%, 57.5%, 58%, 58.5%, 59%, 59.5%, 60%, 60.5%, 61%, 61.5%, 62%, 62.5%, 63%, 63.5%, 64%, 64.5%, 65%, 65.5%, 66%, 66.5%, 67%, 67.5%, 68%, 68.5%, 69%, 69.5%, 70%, 70.5%, 71%, 71.5%, 72%, 72.5%, 73%, 73.5%, 74%, 74.5%, 75%, and 75.5%.

In one aspect, the plant oil based product includes one of avocado oil or extra virgin olive oil in a weight percentage of total content of the product from about 61.5% to about 75.5%, such as when the plant oil based product is to be supported directly within a container (e.g., 8 oz. to 32 oz. plastic tubs). In another aspect, the plant oil based product includes one of avocado oil or extra virgin olive oil in a weight percentage of total content of the product from about 57% to about 70%, such as when the plant oil based product is to be molded in a stick form or other molded form.

In one aspect, the plant oil based product includes a sunflower oil/flaxseed oil mixture in a weight percentage of total content of the product from about 59.5% to about 73%, such as when the plant oil based product is to be supported directly within a container (e.g., 8 oz. to 32 oz. plastic tubs). For example, the sunflower oil/flaxseed oil mixture can include a ratio of sunflower oil to flaxseed oil of about 11.4 to 13.5 sunflower oil: 0.9 to 1.1 flaxseed oil by weight. In another aspect, the plant oil based product includes the sunflower oil/flaxseed oil mixture in a weight percentage of total content of the product from about 55% to about 68%, such as when the plant oil based product is to be molded in a stick form or other molded form.

Structuring Oil

The plant oil based product includes at least one structuring oil having a melting point at a higher temperature than the liquid oil to provide structure for the product at temperatures exceeding refrigerated temperatures (e.g., room temperatures). As used herein, room temperatures generally refer to temperatures from about 20° C. (68° F.) to about 25° C. (77° F.). In an aspect, the structuring oil has a solid or semisolid structure at room temperatures, but melts into a liquid at temperatures below human body temperature (generally between about 36° C. (97° F.) to 37° C. (99° F.)). Such a profile can provide structure for the plant oil based product between refrigerated and room temperatures, but melts into a liquid when in the mouth of the consumer, providing for a uniform and clean mouthfeel. For example, in an aspect, the structuring oil has a solid fat content of at least 60% at a temperature of 21.1° C. (70° F.). The structuring oil can include, but is not limited to, coconut oil, palm kernel oil, palm oil, cocoa butter, algae oil, and combinations thereof. In some aspects, the structuring oil is a fractionated or transesterified oil. The structuring oil may be extracted from the various plant sources via mechanical pressing without chemical solvents.

In one aspect, the plant oil based product includes the structuring oil in a weight percentage of total content of the product from about 20% to about 40%. In another aspect, the plant oil based product includes the structuring oil in a weight percentage of total content of the product from about 27% to about 38.5% For example, the weight percentage of the structuring oil in the plant oil based product can be from about 27%, 27.5%, 28%, 28.5%, 29%, 29.5%, 30%, 30.5%, 31%, 31.5%, 32%, 32.5%, 33%, 33.5%, 34%, 34.5%, 35%, 35.5%, 36%, 36.5%, 37%, 37.5%, 38%, and 38.5% to about 27%, 27.5%, 28%, 28.5%, 29%, 29.5%, 30%, 30.5%, 31%, 31.5%, 32%, 32.5%, 33%, 33.5%, 34%, 34.5%, 35%, 35.5%, 36%, 36.5%, 37%, 37.5%, 38%, and 38.5%.

In one aspect, the plant oil based product includes palm kernel oil in a weight percentage of total content of the product from about 27% to about 33%, such as when the plant oil based product is to be supported directly within a container (e.g., 8 oz. to 32 oz. plastic tubs). For example, the palm kernel oil can be present with one of avocado oil or extra virgin olive oil in the product. In another aspect, the plant oil based product includes palm kernel oil in a weight percentage of total content of the product from about 31.5% to about 38.5%, such as when the plant oil based product is to be molded in a stick form or other molded form. For example, the palm kernel oil can be present with one of avocado oil or extra virgin olive oil in the product.

In one aspect, the plant oil based product includes palm kernel oil in a weight percentage of total content of the product from about 28.8% to about 35.2%, such as when the plant oil based product is to be supported directly within a container (e.g., 8 oz. to 32 oz. plastic tubs). For example, the palm kernel oil can be present with a sunflower oil/flaxseed oil mixture in the product. In another aspect, the plant oil based product includes the sunflower oil/flaxseed oil mixture in a weight percentage of total content of the product from about 33.3% to about 40.7%, such as when the plant oil based product is to be molded in a stick form or other molded form. For example, the palm kernel oil can be present with a sunflower oil/flaxseed oil mixture in the product.

Salt

The plant oil based product can include salt to enhance the flavors of the liquid oil and the structuring oil and to provide a salty flavor to the product. The salt can be of various types (e.g., sea salt, kosher salt, rock salt, and the like) and sizes (e.g., finely ground salt, flour-cut salt, pulverized salt, and the like). In an aspect, the plant oil based product does not include water as an intentionally added ingredient. For example, the plant oil based product includes substantially no water (e.g., less than 1% water by weight of the product, where water could be present as a result of relative humidity in processing environments, residual water in piping from rinsing processes, etc.), so the salt is not in a dissolved state within the product. Instead, the salt is suspended by the oils of the product. The ability of the product to suspend the salt can depend on the stability of the product during temperature transitions. For example, the structuring oil and the liquid oil provide conditions for the salt at refrigerated temperatures and room temperatures to provide sufficient structure to maintain the salt in the suspended state. If a product had substantially less structure than the product described herein, the salt would fall out of suspension (e.g., fall to the bottom of the product or container) as the fat(s) of the product begin to melt during the transition between refrigerated temperature and room temperature. If such melted product is chilled, the salt would remain at the bottom of the product or container, resulting in a non-homogenous product or otherwise providing an imbalanced salt profile from top to bottom of the product. In an aspect, the salt is a powdered or microfine salt which assists with uniform dispersion through and suspension of the salt in the liquid oil and structuring oil blend. For example, the salt can include 200 mesh powdered sea salt.

In one aspect, the plant oil based product includes salt in a weight percentage of total content of the product from about 0% to about 3%. In another aspect, the plant oil based product includes salt in a weight percentage of total content of the product from about 0.5% to about 2.0% For example, the weight percentage of salt in the plant oil based product can be from about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, and 2.0% to about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, and 2.0%.

Sweeteners, Flavorings, and Additional Ingredients

The plant oil based product can include sweeteners, flavoring agents, or combinations thereof to sweeten, flavor, or enhance the product in addition to, or in the absence of, salt. For example, the additional sweeteners and flavoring agents may include, but are not limited to, honey (e.g., extra light amber honey), molasses (e.g., unsulphured sugarcane molasses), citric acid, spices, brown sugar, cinnamon, natural flavors, artificial flavors, fruit, vegetable, or herb powders, extracts, or oleoresins, and the like. In one aspect, the spread includes substantially no water (e.g., less than 1% water by weight of the product) so that emulsifiers and preservatives are not included, since any added sweeteners or flavoring agents would be suspended in the liquid oil and structuring oil blend as opposed to dissolved in water. For example, the plant oil based product can include less than 0.01% emulsifiers by weight of the product, less than 0.01% preservatives by weight of the product, and combinations thereof. Food grade emulsifiers can include, but are not limited to, lecithin, mono- and diglycerides, polysorbates, carrageenan, agar-agar, xanthan gum, guar gum, polyglycerol esters, propylene glycol esters, stearoyl lactylates, polysorbates, and the like. Food grade preservatives can include, but are not limited to, ascorbic acid, citric acid, sorbic acid, benzoic acid, sodium benzoate, tocopherols, calcium phosphate, and the like. In one aspect, no component of the plant oil based product is derived or provided from dairy or soy sources (e.g., no dairy or soy ingredients included in the plant oil based product, with dairy and soy components below limits of allergen tests). For example, the plant oil based product can be dairy free (e.g., less than 0.01% by weight dairy), soy free (e.g., e.g., less than 0.01% by weight dairy), and vegan.

### Structural Characteristics of the Plant Oil Based Product

Solid Fat Content

The plant oil based product exhibits spreadable and stable properties at both refrigerated temperatures and room temperatures without added emulsifiers, preservatives, or chemical additives. Since the spreadable plant oil based product has no water or has substantially no water (e.g., less than 1% water by weight of the product), the salt is distributed through and suspended within the spreadable plant oil based product, but not dissolved in the spreadable plant oil based product. In one aspect, the plant oil based product has a solid fat content from about 19.1% to about 25% at 40° F., a solid fat content from about 13.9% to about 19% at 50° F., a solid fat content from about 9.4% to about 13.6% at 60° F., and a solid fat content from about 3.4% to about 5.5% at 70° F. The liquid oil used in the plant oil based product has a solid fat content below about 0.4% at temperatures from 40° F. to 70° F., whereas the structuring oil used in the plant oil based product has a solid fat content greater than about 70.3% at temperatures from 40° F. to 70° F. A traditional butter product has a solid fat content of about 49.7% at 40° F., a solid fat content of about 41.7% at 50° F., a solid fat content of about 30.5% at 60° F., and a solid fat content of about 17.2% at 70° F. The solid fat content of the plant oil based product provides structural stability of the product at room temperatures and at refrigerated temperatures, thereby permitting the product to maintain structural stability during transition from refrigerated temperatures to room temperatures (e.g., during transit of a consumer from a point of purchase, such as a grocery store, to the home of the consumer, during pendency where the product is left out of a refrigerator, and the like). Butter is typically left out at room temperature to allow it to be spreadable, however aspects of the plant oil based product provide solid fat contents at 40° F. similar to the solid fat content of butter at 70° F.

Melting Point

The plant oil based product has a melting point near room temperature and substantially below body temperature to provide a stable and spreadable product at room temperature while completely melting within the mouth of the consumer to provide a clean and uniform mouthfeel. For example, the plant oil based product can have a melting point from about 63.5° F. to about 79° F. In one aspect, the plant oil based product has a melting point from about 68.5° F. to about 74° F. In one aspect, the liquid oil used in the plant oil based product has a melting point from about 11° F. to about 19° F., whereas the structuring oil used in the plant oil based product has a melting point of about 86.4° F. A traditional butter product has a melting point of about 90.8° F. The melting point of the plant oil based product provides structural stability of the product at room temperatures and at refrigerated temperatures, thereby permitting the product to maintain structural stability during transition from refrigerated temperatures to room temperatures (e.g., during transit of a consumer from a point of purchase, such as a grocery store, to the home of the consumer, during pendency where the product is left out of a refrigerator, and the like).

Spreadability

The spreadability of a product can be correlated to the excess stress required to begin to make the product flow at a particular rate, which is referred to as stress overshoot. The magnitude of the stress overshoot of a material can be determined by rheometry (e.g., with a rotational rheometer), where the lower the stress overshoot, the less stress required to make the product flow. For example, in general, the lower the stress overshoot, the more spreadable the material is. As described herein, all stress overshoot tests were performed on an Anton Paar MCR 102 rheometer using a serrated 25 mm parallel plate on a serrated surface. The serrated surface was selected to reduces the possibility of slip in oil-based samples. Temperature was controlled using a P-PTD200+H-PTD200 plate and hood system. Samples were sheared at a constant shear rate of 7.5 s⁻¹, and the spreadability was the maximum force from the stress overshoot.

In one aspect, the plant oil based product has a stress overshoot from about 4,000 Pascals (Pa) to about 8,000 Pa at a temperature of 40° F. In one aspect, the liquid oil used in the plant oil based product has an undeterminable stress overshoot at 40° F., where the liquid nature of the liquid oil does provide a computable stress overshoot (e.g., approximately zero Pa). The structuring oil used in the plant oil based product has a stress overshoot at 40° F. exceeding 43,600 Pa, where the solid fat content is too high to accurately measure the stress overshoot since the structuring oil is not readily spreadable in that state. Similarly, a traditional butter product has a stress overshoot at 40° F. exceeding 43,600 Pa, where the solid fat content of the butter is too high to accurately measure the stress overshoot since the butter is not readily spreadable in that state.

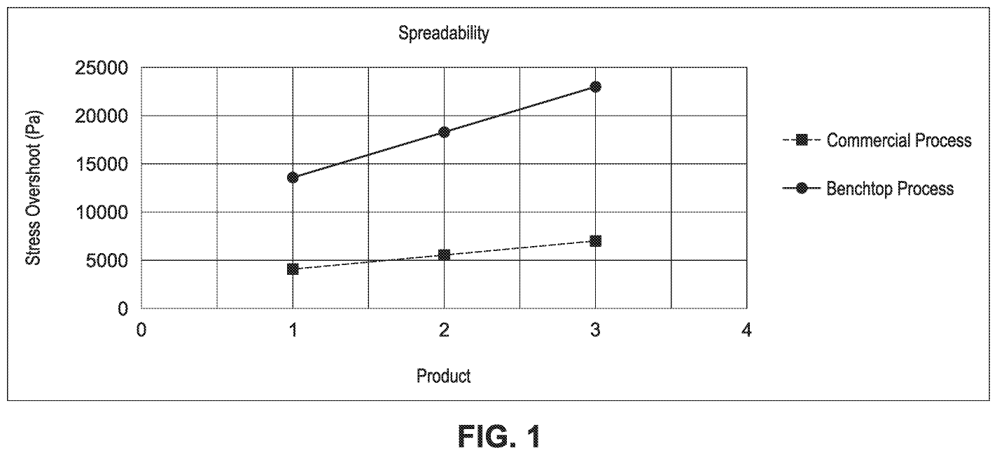

The ingredients of the plant oil based product can be treated with commercial mixing, cooling, shearing, and aeration techniques to provide a spreadability not obtainable through benchtop or countertop mixing of the same formulations. For example, the ingredients can be agitated while rapidly cooling in a scraped surface heat exchanger to prevent fatty acids from fully aligning in their crystalline matrix. The mixed ingredients can then be transferred to a pin worker to mechanically work (e.g., shear) without additional cooling to provide a desired crystallization structure by shearing and permitting the heat of crystallization to occur. Following mechanical working, the product is aerated (e.g., via nitrogen introduction) to form voids or pockets in or between the crystal structure. Alternatively or additionally, aeration can occur prior to cooling in the scraped surface heat exchanger, where the oil traps the aerating gas once the solid fat content increases following the initial mixing of oils. Referring to FIG. 1, a chart showing the stress overshoot of a plurality of products is shown. The data series labeled “Commercial Process” refers to plant oil based products prepared with the commercial mixing, cooling, shearing, and aeration techniques, whereas the data series labeled “Benchtop Process” refers to plant oil based products that have been prepared according to benchtop techniques (i.e., the liquid oil and the structuring oil are melted and blended with salt and placed in a refrigerator to crystalize without agitation or aeration). The weight percentages of ingredients and the ingredient types of the Commercial Process plant oil based products and the Benchtop Process products are the same.

Fatty Acid Composition

The plant oil based product has a fatty acid composition to provide a solid fat content at refrigerated temperatures for spreadability while providing stability at room temperatures and also while completely melting within the mouth of the consumer to provide a clean and uniform mouthfeel. For example, the plant oil based product can have a fatty acid composition with a saturated fat content from about 27.7 g/100 g to about 36.9 g/100 g, a polyunsaturated fat content from about 5.4 g/100 g to about 15.7 g/100 g, and a monounsaturated fat content from about 35.4 g/100 g to about 53.9 g/100 g. In one aspect, the liquid oil used in the plant oil based product has a fatty acid composition with a saturated fat content from about 7.6 g/100 g to about 20.4 g/100 g, a polyunsaturated fat content from about 13.0 g/100 g to about 17.7 g/100 g, and a monounsaturated fat content from about 59.0 g/100 g to about 70.5 g/100 g, whereas the structuring oil used in the plant oil based product has a fatty acid composition with a saturated fat content of about 88.9 g/100 g, a polyunsaturated fat content of about 0.8 g/100 g, and a monounsaturated fat content of about 5.1 g/100 g. A traditional butter product has a fatty acid composition with a saturated fat content of about 50.7 g/100 g, a polyunsaturated fat content of about 2.5 g/100 g, and a monounsaturated fat content of about 14.6 g/100 g.

### Example 1—Avocado Oil and Palm Kernel Oil

A first plant oil based product was prepared according to the Commercial Process and a second plant oil based product was prepared according to the Benchtop Process, with each product having a composition of 68.5% by weight avocado oil, 30% by weight palm kernel oil, and 1.5% by weight salt. The first plant oil based product had a spreadability of about 6400 Pa, a melting point of about 71.1° F., a solid fat content of about 22.7% at 40° F., 16.7% at 50° F., 11.4% at 60° F., and 4.5% at 70° F., and a fatty acid composition with a saturated fat content of about 33.6 g/100 g, a polyunsaturated fat content of about 14.3 g/100 g, and a monounsaturated fat content of about 39.2 g/100 g. The second plant oil based product had a spreadability of about 20300 Pa, a melting point of about 69.7° F., a solid fat content of about 27.0% at 40° F., 19.8% at 50° F., 12.6% at 60° F., and 5.3% at 70° F., and a fatty acid composition with a saturated fat content of about 38.2 g/100 g, a polyunsaturated fat content of about 8.4 g/100 g, and a monounsaturated fat content of about 41.9 g/100 g. The liquid oil (avocado oil) and the structuring oil (palm kernel oil) were also evaluated, where the liquid oil had an indeterminable spreadability (approximately 0 Pa), a melting point of about 13.1° F., a solid fat content of about 0% at 40° F. through 70° F., and a fatty acid composition with a saturated fat content of about 18.3 g/100 g, a polyunsaturated fat content of about 13.0 g/100 g, and a monounsaturated fat content of about 64.3 g/100 g, and where the structuring oil had an indeterminable spreadability (exceeding instrument limit of 43,600 Pa), a melting point of about 86.4° F., a solid fat content of about 86.4% at 40° F., 80.9% at 50° F., 77.0% at 60° F., and 70.3% at 70° F., and a fatty acid composition with a saturated fat content of about 88.9 g/100 g, a polyunsaturated fat content of about 0.8 g/100 g, and a monounsaturated fat content of about 5.1 g/100 g.

### Example 2—Olive Oil and Palm Kernel Oil

A first plant oil based product was prepared according to the Commercial Process and a second plant oil based product was prepared according to the Benchtop Process, with each product having a composition of 68.5% by weight extra virgin olive oil, 30% by weight palm kernel oil, and 1.5% by weight salt. The first plant oil based product had a spreadability of about 4600 Pa, a melting point of about 70.7° F., a solid fat content of about 21.2% at 40° F., 15.5% at 50° F., 10.4% at 60° F., and 4.5% at 70° F., and a fatty acid composition with a saturated fat content of about 32.1 g/100 g, a polyunsaturated fat content of about 6.0 g/100 g, and a monounsaturated fat content of about 49.0 g/100 g. The second plant oil based product had a spreadability of about 15000 Pa, a melting point of about 70.1° F., a solid fat content of about 25.8% at 40° F., 19.6% at 50° F., 12.7% at 60° F., and 5.2% at 70° F., and a fatty acid composition with a saturated fat content of about 39.2 g/100 g, a polyunsaturated fat content of about 10.3 g/100 g, and a monounsaturated fat content of about 38.0 g/100 g. The liquid oil (extra virgin olive oil) and the structuring oil (palm kernel oil) were also evaluated, where the liquid oil had an indeterminable spreadability (approximately 0 Pa), a melting point of about 18.7° F., a solid fat content of about 0% at 40° F. through 70° F., and a fatty acid composition with a saturated fat content of about 20.4 g/100 g, a polyunsaturated fat content of about 16.2 g/100 g, and a monounsaturated fat content of about 59.0 g/100 g, and where the structuring oil had an indeterminable spreadability (exceeding instrument limit of 43,600 Pa), a melting point of about 86.4° F., a solid fat content of about 86.4% at 40° F., 80.9% at 50° F., 77.0% at 60° F., and 70.3% at 70° F., and a fatty acid composition with a saturated fat content of about 88.9 g/100 g, a polyunsaturated fat content of about 0.8 g/100 g, and a monounsaturated fat content of about 5.1 g/100 g.

### Example 3—Sunflower/Flaxseed Mixture and Palm Kernel Oil

A first plant oil based product was prepared according to the Commercial Process and a second plant oil based product was prepared according to the Benchtop Process, with each product having a composition of 61.5% by weight sunflower oil, 5% by weight flaxseed oil, 32% by weight palm kernel oil, and 1.5% by weight salt. The first plant oil based product had a spreadability of about 6400 Pa, a melting point of about 71.9° F., a solid fat content of about 21.9% at 40° F., 17.3% at 50° F., 12.4% at 60° F., and 5.0% at 70° F., and a fatty acid composition with a saturated fat content of about 30.8 g/100 g, a polyunsaturated fat content of about 10.0 g/100 g, and a monounsaturated fat content of about 45.8 g/100 g. The second plant oil based product had a spreadability of about 21000 Pa, a melting point of about 73.0° F., a solid fat content of about 23.4% at 40° F., 19.4% at 50° F., 14.3% at 60° F., and 6.5% at 70° F., and a fatty acid composition with a saturated fat content of about 33.5 g/100 g, a polyunsaturated fat content of about 13.1 g/100 g, and a monounsaturated fat content of about 41.1 g/100 g. The base liquid oil (sunflower oil) and the structuring oil (palm kernel oil) were also evaluated, where the base liquid oil had an indeterminable spreadability (approximately 0 Pa), a melting point of about 11.5° F., a solid fat content of about 0% at 40° F. through 70° F., and a fatty acid composition with a saturated fat content of about 7.6 g/100 g, a polyunsaturated fat content of about 17.7 g/100 g, and a monounsaturated fat content of about 70.5 g/100 g, and where the structuring oil had an indeterminable spreadability (exceeding instrument limit of 43,600 Pa), a melting point of about 86.4° F., a solid fat content of about 86.4% at 40° F., 80.9% at 50° F., 77.0% at 60° F., and 70.3% at 70° F., and a fatty acid composition with a saturated fat content of about 88.9 g/100 g, a polyunsaturated fat content of about 0.8 g/100 g, and a monounsaturated fat content of about 5.1 g/100 g.

### Plant Oil Based Product Example Production Process

Referring to FIG. 1, a process 100 for producing an example plant oil based product is shown. The process 100 includes combining the liquid oil and the structuring oil together and mixing to provide a substantially homogeneous mixture in operation 102. The total amount of oil mixed during operation 102 generally depends on the batch size and/or flow rate of the process 100, and can include, for example, between about 4,000 pounds and 10,000 pounds of oil, with a product flow rate from the process 100 from about 75 lbs/min to about 200 lbs/min. In one aspect, the liquid oil and the structuring oil are introduced to a heated mixing vessel operating at a temperature exceeding the melting point of each of the liquid oil and the structuring oil. For example, the heated mixing vessel may operate at temperatures from about 110° F. to 180° F. to maintain the liquid oil and the structuring oil in their respective liquid states while blending the two oils together in a substantially homogeneous mixture. Alternatively or additionally, one or more of the liquid oil and the structuring oil may be melted into a liquid state prior to introduction to the heated mixing vessel.

The process 100 can also include introducing one or more of salt, seasoning, sweetening agents, or flavoring agents to the blended oils in operation 104. For example, one or more of salt, seasoning, sweetening agents, or flavoring agents can be introduced to the heated mixing vessel to blend the added ingredients together with the blended oil to produce a substantially homogeneous mixture. Alternatively or additionally, the additional ingredients, or a portion thereof, can be introduced to a separate mixing vessel for additional and blending.

Following the optional seasoning or flavoring addition, the blended mixture is permitted to at least partially crystallize in operation 106. The process 100 controls crystallization conditions by subjecting the blended mixture to rapid cooling while simultaneously agitating the blended mixture to prevent the fatty acids in the blended mixture from fully aligning in a crystalline matrix. For example, the blended mixture can be introduced to one or more scraped surface heat exchangers to reduce the temperature of the blended mixture to a temperature from about 40° F. to about 60° F. with a residence time of less than about 75 seconds.

The process 100 then proceeds to operation 108, where the cooled blended mixture is subjected to shear mixing to direct the crystallization structure of the cooled blended mixture to form. The shear mixing generally inputs mechanical work to the cooled blended mixture without controlled cooling or heating (e.g., under ambient conditions) to permit the heat of crystallization to occur to drive the crystallization structure of the cooled blended mixture to a Beta Prime crystal instead of the Beta crystallization formation that would occur without the shear mixing. The Beta Prime crystal structure of the product has been found to contribute to a smooth texture, permitting spreadability that is not found in Beta crystal structure spreads, where the Beta crystal structure contributes a grainy and rough texture. In one aspect, the cooled blended mixture is introduced to a pin worker having a plurality of rotating pins interacting with the cooled blended mixture to input mechanical work without cooling the cooled blended mixture. For example, the pin worker can include a tube having internal pins rotating within the pins to mechanically work fluids flowing through the interior of the tube. In one aspect, the pin worker rotates the pins within the interior of the tube from about 140 rotations per minute (rpm) to about 220 rpm, with a residence time of the cooled blended mixture from about 25 to about 55 seconds.

The process 100 further includes aerating the blended mixture in operation 110 following the shear mixing to produce a plant oil based product described herein. For example, the mixture can leave the pin worker having the Beta Prime crystal configuration with the specific ratio of liquid oil to structuring oil as a homogenous mixture, where the mixture is introduced to a commercial aerator to introduce a gas (e.g., nitrogen or other food safe gas) to form voids or pockets in or between the crystal structure, which can facilitate a soft and less dense texture while preventing a waxy visual appearance. In one aspect, nitrogen is introduced to the mixture to provide an overrun percentage from about 20% to about 30%, where overrun percentage can be measured according to equation (1):

$$\% Overrun = \frac{\begin{matrix}\{ ( Unwhipped Weight - Tare Weight ) - \\ ( Whipped Weight - Tare Weight ) \}\end{matrix}}{Whipped Weight - Tare Weight} \times 100$$

where “Tare Weight” represents the weight of the empty container with fixed volume used to hold the samples during measurements. Alternatively or additionally, aeration can occur prior to crystallization during operation 106, where the blended oil ingredients trap the aerating gas once the solid fat content increases following the initial mixing of oils in operation 102.

The process 100 can also include preparing the plant oil based product for packaging and distribution in operation 112. For example, of the plant oil based product is to be molded into a particular shape (e.g., a stick shape or other shape), the plant oil based produce can be introduced to molds to set at the particular shape before wrapping and packaging. Alternatively or additionally, the plant oil based product is introduced to a container (e.g., 8 oz. to 32 oz. plastic tubs or the like) which is subsequently sealed for distribution. In an aspect, for molded plant oil based products, the plant oil based product is introduced to a resting tube following crystallization to permit the product to solidify/crystallize further prior to shaping.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A plant oil based spread comprising:
a plant-based liquid oil from about 57% to about 75.5% by weight;
a structuring oil from about 27% to about 38.5% by weight blended with the plant-based liquid oil;
salt from about 0.5% to about 3.0% by weight, the salt suspended in the blended plant-based liquid oil and structuring oil,
wherein the plant oil based spread includes less than 1% by weight water, less than 0.01% by weight dairy or dairy-derived products, and less than 0.01% by weight soy or soy-derived products, and wherein the plant oil based spread has a stress overshoot from about 4000 Pa to about 8000 Pa at a temperature of 40° F.

2. The plant oil based spread of claim 1, wherein the plant-based liquid oil includes at least one of olive oil, avocado oil, canola oil, sunflower seed oil, flaxseed oil, walnut oil, tomato seed oil, and grape seed oil.

3. The plant oil based spread of claim 1, wherein the structuring oil includes at least one of palm kernel oil and coconut oil.

4. The plant oil based spread of claim 1, wherein the plant-based liquid oil includes at least one of olive oil, avocado oil, and sunflower seed oil, and wherein the structuring oil includes palm kernel oil.

5. The plant oil based spread of claim 1, wherein the plant oil based spread has a solid fat content from about 19.1% to about 25% at 40° F.

6. The plant oil based spread of claim 1, wherein the plant oil based spread has a solid fat content from about 3.4% to about 5.5% at 70° F.

7. The plant oil based spread of claim 1, wherein the plant oil based spread includes an emulsifier in an amount less than 0.01% by weight.

8. The plant oil based spread of claim 1, wherein the plant oil based spread includes a preservative in an amount less than 0.01% by weight.

9. The plant oil based spread of claim 1, wherein the plant oil based spread includes the plant based liquid oil in an amount from about 61.5% to about 75.5% by weight.

10. The plant oil based spread of claim 9, wherein the plant oil based spread includes the structuring oil in an amount from about 27% to about 33% by weight.

11. The plant oil based spread of claim 1, wherein the plant oil based spread includes the plant based liquid oil in an amount from about 57% to about 70% by weight.

12. The plant oil based spread of claim 11, wherein the plant oil based spread includes the structuring oil in an amount from about 31.5% to about 38.5% by weight.

13. The plant oil based spread of claim 1, wherein the plant oil based spread has a melting point from about 68.5° F. to about 74° F.

14. The plant oil based spread of claim 1, wherein the plant oil based spread has a fatty acid composition with a saturated fat content from about 27.7 g/100 g to about 36.9 g/100 g, a polyunsaturated fat content from about 5.4 g/100 g to about 15.7 g/100 g, and a monounsaturated fat content from about 35.4 g/100 g to about 53.9 g/100 g.

15. A plant oil based spread comprising:
a plant-based liquid oil from about 57% to about 75.5% by weight;
a structuring oil from about 27% to about 38.5% by weight blended with the plant-based liquid oil;
wherein the plant oil based spread includes less than 1% by weight water and less than 0.01% by weight emulsifier, and wherein the plant oil based spread has a stress overshoot from about 4000 Pa to about 8000 Pa at a temperature of 40° F.

16. The plant oil based spread of claim 15, further including salt, wherein the salt is suspended by the plant-based liquid oil.

17. The plant oil based spread of claim 15, wherein the plant-based liquid oil includes at least one of olive oil, avocado oil, canola oil, sunflower seed oil, flaxseed oil, walnut oil, tomato seed oil, and grape seed oil.

18. The plant oil based spread of claim 15, wherein the structuring oil includes at least one of palm kernel oil and coconut oil.

19. The plant oil based spread of claim 15, wherein the plant-based liquid oil includes at least one of olive oil, avocado oil, and sunflower seed oil, and wherein the structuring oil includes palm kernel oil.

20. The plant oil based spread of claim 15, wherein the plant oil based spread has a solid fat content from about 19.1% to about 25% at 40° F.

21. The plant oil based spread of claim 15, wherein the plant oil based spread has a solid fat content from about 3.4% to about 5.5% at 70° F.

22. The plant oil based spread of claim 15, wherein the plant oil based spread includes the plant based liquid oil in an amount from about 61.5% to about 75.5% by weight.

23. The plant oil based spread of claim 22, wherein the plant oil based spread includes the structuring oil in an amount from about 27% to about 33% by weight.

24. The plant oil based spread of claim 15, wherein the plant oil based spread includes the plant based liquid oil in an amount from about 57% to about 70% by weight.

25. The plant oil based spread of claim 24, wherein the plant oil based spread includes the structuring oil in an amount from about 31.5% to about 38.5% by weight.

26. The plant oil based spread of claim 15, wherein the plant oil based spread has a melting point from about 68.5° F. to about 74° F.

27. The plant oil based spread of claim 15, wherein the plant oil based spread has a fatty acid composition with a saturated fat content from about 27.7 g/100 g to about 36.9 g/100 g, a polyunsaturated fat content from about 5.4 g/100 g to about 15.7 g/100 g, and a monounsaturated fat content from about 35.4 g/100 g to about 53.9 g/100 g.
